(19) United States
(12) Patent Application Publication
(10) Pub. No.: US 2004/0193402 A1
(43) Pub. Date: Sep. 30, 2004

(54) Method and apparatus for wirelessly delivering MP3 content

(76) Inventors: John Timothy Nolan, Cape Coral, FL (US); Anthony Capobianco, Cape Coral, FL (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/401,369

(22) Filed: Mar. 28, 2003

(51) Int. Cl. G10L 19/00

(52) U.S. Cl. 704/200.1

(57) ABSTRACT

A method and apparatus is provided for distributing compressed digital information. The method begins by obtaining compressed digital information. The compressed digital information is then broadcast in accordance with a wireless protocol from within a given venue to a mobile information player that enters the given venue in which the compressed digital information is transmitted. The mobile information player is adapted to receive, uncompress, and play the compressed digital information.

### FIELD OF THE INVENTION

The present invention relates generally to the wireless transmission of information, and more particularly to the transmission of compressed audio information in a format such as MP3 or ATRAC to a mobile digital audio player.

### BACKGROUND OF THE INVENTION

Portable audio players that can play music or other audio information have become ubiquitous in recent years. Until recently most portable audio players such as portable tape and CD (compact disk) players generally were not capable of storing and receiving audio information over a computer network such as the Internet. Rather, such players were required to play audio from physical media on which the audio was prerecorded, such as tapes and CDs. Recently, however, portable audio players have been developed that can play a compressed digital format known as the Moving Pictures Experts Group audio layer-3 (MP3). Since the MP3 format is digital, audio stored in the MP3 format can be readily communicated over computer networks. In fact, there has recently been an explosion of music that has been converted to the MP3 format and which is made available on the World Wide Web for individual use.

Individual users can download from the Internet audio information that is embodied in MP3-formatted files using a computer and specialized software. Furthermore, a personal computer programmed with the appropriate software can convert digital audio from a CD into the MP3 format. Currently, MP3 files can be played in three different ways: (i) MP3 files can be played directly on a personal computer, (ii) MP3 files can be decompressed and recorded onto a CD, and (iii) the MP3 files can be played on an MP3 player. Thus, a user can download MP3 files from the Internet and load such MP3 files onto the MP3 player. Typically, the MP3 player can be connected to the personal computer's parallel or USB port in order to receive the downloaded MP3 files. Alternatively, MP3 players may employ non-volatile memory such as a memory stick on which the MP3 files are stored.

One feature common to the various methods described above for transferring MP3 files to a portable MP3 player is that the user dictates the audio content that is to be played and must actively transfer the desired audio content to the MP3 player.

### SUMMARY OF THE INVENTION

In accordance with the present invention, a method and apparatus is provided for distributing compressed digital information. The method begins by obtaining compressed digital information. The compressed digital information is then broadcast in accordance with a wireless protocol from within a given venue to a mobile information player that enters the given venue in which the compressed digital information is transmitted. The mobile information player is adapted to receive, uncompress, and play the compressed digital information.

In accordance with one aspect of the invention, the compressed digital information is compressed audio information.

In accordance with another aspect of the invention, the compressed audio information is compressed in accordance with an MP3 format.

In accordance with another aspect of the invention, the compressed audio information is compressed in accordance with an ATRAC format.

In accordance with another aspect of the invention, the compressed digital information includes still video images.

In accordance with another aspect of the invention, the mobile information player is a portable digital audio player.

In accordance with another aspect of the invention, the mobile information player is a portable MP3 player.

In accordance with another aspect of the invention, the wireless protocol is selected from the group consisting of Bluetooth, IEEE 802.11, IEEE 802.15, IEEE802.16, Near Field Communication—Interface and Protocol (“NFCIP-1”), and HomeRF.

### BRIEF DESCRIPTION OF THE DRAWINGS

FIG. 1 shows a compressed digital audio information distribution system in accordance with the present invention.

FIG. 2 shows a block diagram of an exemplary embodiment of a compressed audio distribution device that can be used to broadcast compressed audio such as MP3 files.

FIG. 3 shows a block diagram of an exemplary embodiment of a mobile digital audio player that may be employed in the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present inventors have recognized that there are many situations when it would be desirable to broadcast compressed audio information from a designated transmission point to a portable player that can store and play the compressed audio format. For example, it may be desirable for advertising or other purposes to distribute to a selected audience audio samples from movie soundtracks, concerts, political rallies, and the like. For example, compressed audio from a movie or concert may be broadcast in the venue in which the movie or concert is performed at the end of the performance. In this way movie- or concert-goers equipped with the appropriate audio player can be easily provided with a sample of the movie or concert. The audio sample may serve as promotional material that serves as advertising to facilitate sales of recorded copies such as a CD of the concert or soundtrack. As another example, a gasoline station or shopping mall, for instance, can broadcast compressed audio information such as advertisements to individuals who enter their premises. Instead of advertisements, the gasoline station or shopping mall may wish to broadcast content such as popular music or the like that is designed to increase the number of repeat customers that enter their premises.

In accordance with the present invention, a compressed audio distribution system is provided in which a venue operator broadcasts compressed digital audio information to a mobile (e.g., a portable or automotive) compressed digital audio player. The broadcast extends over a limited range that in some cases may be several yards (e.g., when the venue is a gasoline station), hundreds of yards (e.g., when the venue is stadium), or even several miles (e.g., when the venue operator is a highway or park authority). The audio may be compressed in accordance with any protocol known to those of ordinary skill in the art. For example, the audio may be compressed in accordance with the MP3 protocol or the Adaptive Transform Acoustic Coding (ATRAC) protocol. In some embodiments of the invention the audio distribution device repeatedly transmits one or more compressed audio clips. After the last audio clip is transmitted, the entire sequence can be repeated a preprogrammed number of times or for as long a period of time as desired. On some devices the user may elect to purchase the entire audio program in whatever form it is distributed.

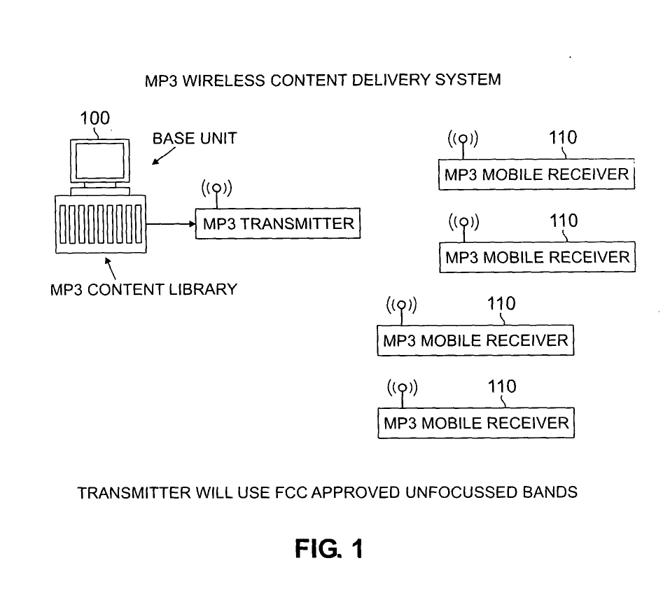

FIG. 1 shows a representational example of such a distribution system. As shown, a compressed audio distribution device 100 resides on the premises of the venue operator. The distribution device 100 may be any device that can store and broadcast compressed audio information. For example, as shown in FIG. 1, the distribution device 100 may be a personal computer. Of course, distribution device 100 encompasses a wide variety of alternative arrangements such as a dedicated device configured to exclusively store and wirelessly broadcast compressed digital audio information.

FIG. 1 also shows several mobile compressed digital audio players 110 that include a receiver suitable for receiving the compressed audio information broadcast by the distribution device 100. Digital audio players 110 may be conventional MP3 players in which an appropriate receiver is incorporated. Alternatively, the digital audio player may be incorporated in another devices such a personal digital assistance, mobile telephone, or Internet appliance, for example.

Specific embodiments of both the compressed audio distribution device 100 and the mobile compressed digital audio players 110 will be presented below for purposes of illustration only and not as a limitation on the invention.

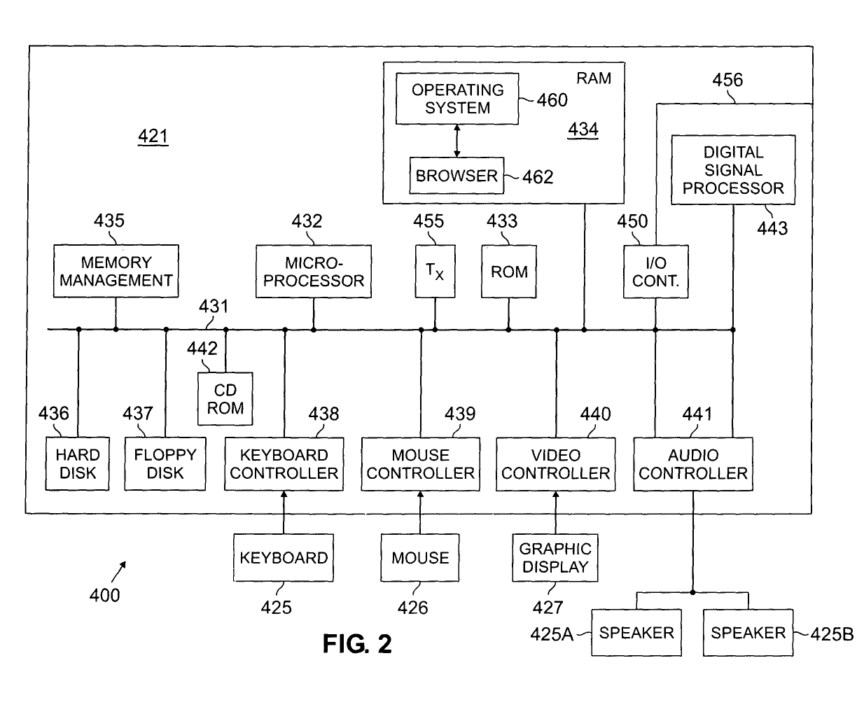

FIG. 2 shows a block diagram of an exemplary embodiment of a compressed audio distribution device that can be used to broadcast compressed audio such as MP3 files. The distribution device 400 includes a system bus or plurality of system buses 431 to which various components are coupled and by which communication between the various components is accomplished. The microprocessor 432 is connected to the system bus 431 and is supported by read only memory (ROM) 433 and random access memory (RAM) 434 also connected to system bus 431. The ROM 433 contains among other code the Basic Input-Output system (BIOS), which controls basic hardware operations such as the interaction of the disk drives and the keyboard. The RAM 434 is the main memory into which the operating system and application programs are loaded. The memory management chip 435 is connected to the system bus 431 and controls direct memory access operations including, passing data between the RAM 434 and hard disk drive 436 and floppy disk drive 437. CD ROM 442 and wireless transmitter 455 are also coupled to the system bus 431. The CD ROM 442 is used to store a large amount of data, e.g., compressed audio data, a multimedia program or large database. Also connected to this system bus 431 are various I/O controllers: the keyboard controller 438, the mouse controller 439, the video controller 440, and the audio controller 441. The keyboard controller 438 provides the hardware interface for the keyboard 25, the controller 439 provides the hardware interface for the mouse (or other point and click device) 426, the video controller 440 is the hardware interface for the display 427, and the audio controller 441 is the hardware interface for the multimedia speakers 425a and 425b. A network interface card (NIC) interfaces to the I/O controller 450 to enable communication via path 456 to other computers over the computer network.

The distribution device 400 may receive the compressed digital content that is to be broadcast by a variety of means. For example, the digital content may be provided on a CD that is read by CD ROM 442. Alternatively, or in addition thereto, the digital content may be received from a content provider over a computer network such as the Internet via communication path 456.

Wireless transmitter 455 complies with a communication standard, preferably a broadcastable wireless protocol, such as Bluetooth, IEEE 802.11, IEEE 802.15, IEEE802.16, Near Field Communication—Interface and Protocol (“NFCIP-1”), and HomeRF. Of course, other wireless protocols can be implemented, which may operate at a variety of different communication frequencies. While in FIG. 1 the wireless transmitter 455 is shown directly connected to system bus 431, those of ordinary skill in the art will recognize that the wireless transmitter 455 may be connected via a cable that connects to a Universal Synchronous Bus (USB) port or parallel port of the compressed audio distribution device.

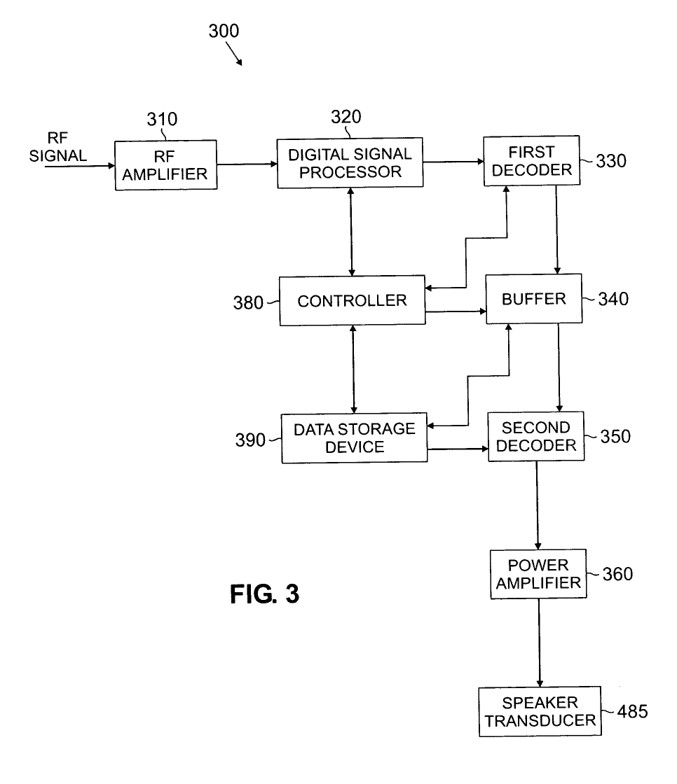

FIG. 3 shows a block diagram of a mobile digital audio player 110 depicted in FIG. 1, which can play a compressed audio format and includes a wireless receiver that complies with the wireless protocol employed by the wireless transmitter 455. In this embodiment of the invention mobile digital audio player 110 is an MP3 player.

As shown, the MP3 player 300 has an RF amplifier 410 for amplifying an RF signal received from the audio distribution device. The unit 300 also includes a digital signal processor 320 for signal-processing the amplified RF signal received by the RF amplifier 310 to extract the compressed audio signal from the carrier in a known manner. A first decoder 330 is provided for correcting errors in the compressed audio data extracted from the digital signal processor 320. A buffer 340 stores the error-corrected audio data from the first decoder 330 for a predetermined time. The error corrected, compressed audio signal also may be stored in a data storage device 390 for subsequent playback. Data storage device 390 may be a magnetic hard disk, optical storage unit, memory stick, flash memory card, or other non-volatile memory. A second decoder 350 reads the error-corrected audio data from the temporary memory 340 or from the data storage device 390 and uncompresses the data. An audio converter 360 converts the uncompressed digital audio signal received from the second decoder 350 into an analog audio signal. An amplifier 360 amplifies the analog audio signal to drive a speaker transducer 385 that generates the audio for the listener. The aforementioned components all operate under the direction and control of a controller 380.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. As another example, while the present invention has been described in terms of a method and apparatus for broadcasting compressed audio information, the present invention is also applicable to the broadcasting of compressed still images, or even brief video clips, instead of, or in addition to, compressed audio. Furthermore, these examples should not be interpreted to limit the modifications and variations of the invention covered by the claims but are merely illustrative of possible variations.

1. A method for distributing compressed digital information, comprising:
obtaining compressed digital information; and
broadcasting in accordance with a wireless protocol and from within a given venue the compressed digital information to a mobile information player that enters the given venue in which the compressed digital information is transmitted, said mobile information player being adapted to receive, uncompress, and play the compressed digital information.

2. The method of claim 1 wherein said compressed digital information is compressed audio information.

3. The method of claim 1 wherein said compressed audio information is compressed in accordance with an MP3 format.

4. The method of claim 3 wherein said compressed audio information is compressed in accordance with an ATRAC format.

5. The method of claim 1 wherein said compressed digital information includes still video images.

6. The method of claim 1 wherein said mobile information player is a portable digital audio player.

7. The method of claim 3 wherein said mobile information player is a portable MP3 player.

8. The method of claim 1 wherein said wireless protocol is selected from the group consisting of Bluetooth, IEEE 802.11, IEEE 802.15, IEEE802.16, Near Field Communication—Interface and Protocol (“NFCIP-1”), and HomeRF.

9. An apparatus for distributing compressed digital information, comprising:
means for obtaining compressed digital information; and
means for broadcasting in accordance with a wireless protocol and from within a given venue the compressed digital information to a mobile information player that enters the given venue in which the compressed digital information is transmitted, said mobile information player being adapted to receive, uncompress, and play the compressed digital information.

10. The apparatus of claim 9 wherein said compressed digital information is compressed audio information.

11. The apparatus of claim 9 wherein said compressed audio information is compressed in accordance with an MP3 format.

12. The apparatus of claim 11 wherein said compressed audio information is compressed in accordance with an ATRAC format.

13. The apparatus of claim 9 wherein said compressed digital information includes still video images.

14. The apparatus of claim 9 wherein said mobile information player is a portable digital audio player.

15. The apparatus of claim 11 wherein said mobile information player is a portable MP3 player.

16. The apparatus of claim 9 wherein said wireless protocol is selected from the group consisting of Bluetooth, IEEE 802.11, IEEE 802.15, IEEE802.16, Near Field Communication—Interface and Protocol (“NFCIP-1”), and HomeRF.
